(19) United States
(12) Patent Application Publication
(10) Pub. No.: US 2026/0244398 A1
(43) Pub. Date: Aug. 20, 2026

(54) EXTRAVEHICULAR SPEECH INTERFACE FOR AUTOMOTIVE ASSISTANT

(71) Applicant: CERENCE OPERATING COMPANY, Burlington, MA (US)

(72) Inventor: Holger Quast, Ghent (BE)

(21) Appl. No.: 19/156,141

(22) PCT Filed: Feb. 13, 2023
(86) PCT No.: PCT/US2023/012890

§ 371 Date: Aug. 13, 2025

(51) Int. Cl. G06F 3/16; B60R 25/25; B60R 25/31; G06F 21/32; G06F 21/62

(52) U.S. Cl. CPC G06F 3/167; B60R 25/257; B60R 25/31; G06F 21/32; G06F 21/6218

(57) ABSTRACT

Each vehicle in a fleet has an automotive assistant and an external speech interface. A person who is authorized to interact with an automotive assistant of any vehicle from that fleet is detected as being outside a vehicle from that fleet. After having determined that the person is indeed authorized, an automotive assistant in that vehicle communicates with that person. It does so either by receiving an utterance by that person or by transmitting an utterance to that person.

### BACKGROUND

Many vehicles feature an infotainment system that executes an automotive assistant. A user within the vehicle is able to use a speech interface to communicate with this automotive assistant. In some cases, it is possible to communicate with the automotive assistant from outside the vehicle. This is normally carried out by sending commands over a wireless link rather than via a speech interface.

When a user communicates by a wireless link, the automotive assistant has no assurance that the user is one with whom it is authorized to interact. It is therefore typical to carry out an authentication process. Only then will the automotive assistant interact with the user.

The ability to discriminate between users is particularly useful when two or more vehicles with virtual assistants are within range of the user at the time of an attempted interaction. Without some way to determine the particular vehicle towards which a command has been directed, there arises a risk of the incorrect vehicle responding to the command. As a result, a user in a public parking lot who requests the automotive assistant to start the vehicle may inadvertently start several vehicles at the same time.

### SUMMARY

Each vehicle in a fleet has an access controller, an automotive assistant, and an external speech interface. A person who is authorized to interact with an automotive assistant of any vehicle from that fleet is detected as being outside a vehicle from that fleet. After having determined that the person is indeed authorized, the access controller establishes communication between that person and one of the automotive assistants in the fleet using the external speech interface.

In one aspect, the invention features detecting that a person is outside a vehicle that is a member of a fleet of vehicles. Each of those vehicles in the fleet has an infotainment system and an external speech interface that has at least one microphone and speaker outside the vehicle. The infotainment system includes an automotive assistant and an access controller.

The method includes using the access controller to determine that the person is authorized to interact with all automotive assistants in the fleet. After having determined that the person is indeed so authorized, the method continues by establishing communication between that person and a first automotive assistant. This first automotive assistant can be any one of the automotive assistants in the fleet.

With communication having been established, communication takes place between the person and any of the automotive assistants using the external speech interface. This is carried out by using the external speech interface to either receive an utterance from the person or to transmit an utterance to the person.

Among the practices are those that include retrieving, from a device carried by the person, information to be used for determining that the person is authorized to interact with any of the automotive assistants and those that include obtaining biometric data from the person and using the biometric data for determining that the person is authorized to interact with any of the automotive assistants. Among the latter are practices that include receiving an utterance by the person and using the utterance for determining that the person is authorized to interact with any of the automotive assistants.

In some practices, determining that the person is authorized to interact with any of the automotive assistants comprises determining that the person is authorized to interact with any automotive assistant in the fleet of vehicles, each vehicle from the fleet having been encoded with information indicating that is manufactured by a particular manufacturer or by a particular ownership entity.

Still other practices include those in which the first automotive assistant is one from a second vehicle from the fleet of vehicles. In this case, the automotive assistant in question and the external speech interface are in different vehicles. In an alternative practice, the first automotive assistant and the external speech interface are part of the same vehicle.

Still other practices include those that include obtaining information from another vehicle in the fleet, that other vehicle being different from that which carries the external speech interface.

In still other practices, the result of using the external speech interface is that of causing a different vehicle from the fleet of vehicles to execute an action or to carry out mechanical work, including to move under its own power to a designated location or to operate some mechanical or climate control feature of that other vehicle.

In still other practices, the automotive assistant interacts with the person as if it were an automotive assistant of another vehicle in the fleet.

Yet other practices are those in which the automotive assistant, along with automotive assistants in other vehicles in the fleet, cooperate to form a distributed automotive assistant.

Further practices include those in which the person is an authorized driver for a vehicle other than that which carries the external speech interface being addressed and communication is established with the automotive assistant of that vehicle, namely the one for which that person is an authorized driver.

In additional practices, using the automotive assistant in the vehicle to communicate with the user using the external speech interface of the vehicle includes wirelessly retrieving information from a remote server and using the information thus retrieved in the course of communicating with the user.

In another aspect, the invention features an access controller and an automotive assistant. The automotive assistant is one of many automotive assistants, each of which is a constituent of an infotainment system. Likewise, the access controller is one of a many access controllers, each of which is a constituent of one of the infotainment systems.

Each infotainment systems is installed in a corresponding vehicle in a fleet of vehicles.

The access controller is configured to determine whether a person who is outside of the vehicle is a person who is authorized to interact with the automotive assistant and also with all other automotive assistants in the fleet. The access controller is also configured to establish communication between the person and one of the automotive assistants in the fleet after having made the determination. Communication is established using an external speech interface of the vehicle in which the automotive assistant is installed. This external speech interface is one of plural external speech interfaces, each of which is installed in a corresponding one of the vehicles in the fleet of vehicles. The automotive assistant is configured to communicate with any other automotive assistant in the fleet.

Embodiments include those in which the access controller is further configured to establish communication with another automotive assistant in the plurality of automotive assistants.

Some embodiments further include a remote server. In such embodiments, each of the access controllers is configured to establish communication with the remote server.

Still other embodiments include those in which the automotive assistant is configured to solicit information concerning the person from another automotive assistant from the plurality of automotive assistants.

Yet other embodiments include those in which the access controller is configured to retrieve, from portable circuitry carried by the person, information for use in determining whether the person is authorized to interact with all automotive assistants in the fleet and those in which the access controller is configured to obtain biometric information to be used when making such a determination.

In another aspect, the invention features a tangible and non-transitory computer readable medium having encoded thereon instructions that, when executed by an infotainment system of a vehicle that is a member of a fleet of vehicles, cause execution of an access controller and an automotive assistant on the infotainment system. This access controller is configured to detect that a person outside the vehicle is authorized to interact with automotive assistants in all of the vehicles in the fleet and to communicate with the user using an external speech interface of the vehicle. It does so by using the speech interface to either receive an utterance by the person or to transmit an utterance to the person.

All methods recited in the claims are carried out in a non-abstract manner. The various components recited in the claims are non-abstract structures comprising baryonic matter. In operation, these structures consume energy and generate waste heat during operation thereof in a manner consistent with laws of thermodynamics. As used herein, “non-abstract” is the converse of “abstract” as the courts of the United States have defined that term as of the filing date of this application.

Any person who construes the claims as covering abstract subject matter is hereby deemed to have construed the claim in a manner contrary to the specification. Moreover, as of the filing date of this application, all attempts to execute the methods claimed herein within the human mind have proven unsuccessful. Any person who takes the position that the subject matter could not possibly be non-abstract is merely acknowledging the inventive step associated with having made non-abstract that which was formerly believed to only exist in the abstract.

These and other features of the invention will be apparent from the following detailed description and the accompanying figures, in which:

### DESCRIPTION OF DRAWINGS

FIG. 1 shows a user interacting with a vehicle's automotive assistant;

FIG. 2 shows a fleet of vehicles, which includes the vehicle from FIG. 1;

FIG. 3 shows the user next to the vehicle in FIG. 1 with a nearby vehicle from the fleet shown in FIG. 2;

FIG. 4 shows the user after having walked over to the nearby vehicle from FIG. 3; and

FIG. 5 shows a process carried out by the nearby vehicle shown in FIGS. 3 and 4.

### DETAILED DESCRIPTION

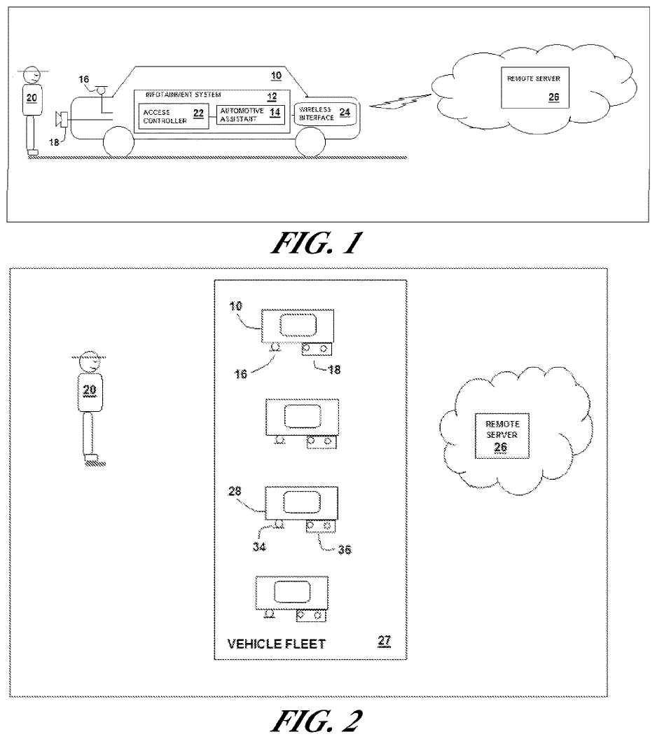

FIG. 1 shows a vehicle 10 having an infotainment system 12 that executes an automotive assistant 14 therein.

The infotainment system 12 interfaces with a microphone 16 and a loudspeaker 18 that are disposed on the vehicle's exterior. As a result, a person 20 outside the vehicle is able to use the infotainment system's access controller 22.

An access controller 22, which also executes in the infotainment system 12, determines whether the person 20 is authorized to interact with the automotive assistant 14. After having determined that this is the case, the access controller 22 permits the person to interact with the automotive assistant 14 from outside the vehicle 12 by using the microphone 16 and the loudspeaker 18, which have been conveniently placed outside the vehicle 10 for precisely this purpose.

The infotainment system 12 connects to a wireless interface 24 to permit communication with a cloud-based remote server 26 that provides the automotive assistant 14 with information that is not be stored locally within the infotainment system 12. Examples of such information include the person's calendar or contact list.

In addition to interacting with the assistant 14 from outside the vehicle shown, the person 20 is able to enter the car and interact with the automotive assistant 14 from inside the vehicle 10. The person 20 is also authorized to use the vehicle 10 for personal transportation, for example by actually driving the vehicle 10 or, in the case of an autonomous vehicle, by providing it with instructions for a destination.

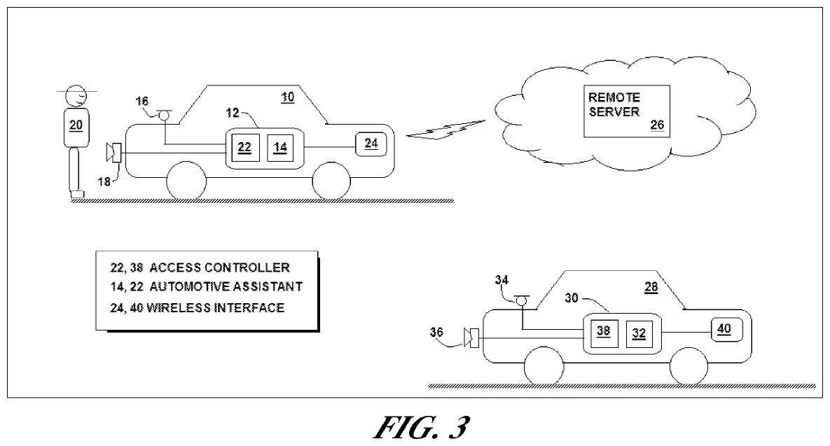

As shown in FIG. 2, the vehicle 10 from FIG. 1 is one of several vehicles in a fleet 27 of vehicles, all of which are equipped in a manner similar to that described in connection with the vehicle 10. In particular, each vehicle has its own access controller 22. A vehicle's access controller 22 determines whether a person outside that vehicle 10 is authorized to interact not only with the automotive assistant 14 in that vehicle's infotainment system 12 but with all of the automotive assistants in the fleet 27.

In some embodiments, the fleet 27 comprises vehicles 10 manufactured by the same manufacturer. In others, the fleet 27 comprises vehicles 10 that are used by a law enforcement or other government agency or by a commercial entity. In still other embodiments, the fleet 27 comprises vehicles 10 whose owners have elected to permit cooperation between automotive assistants 14 of their respective vehicles 10.

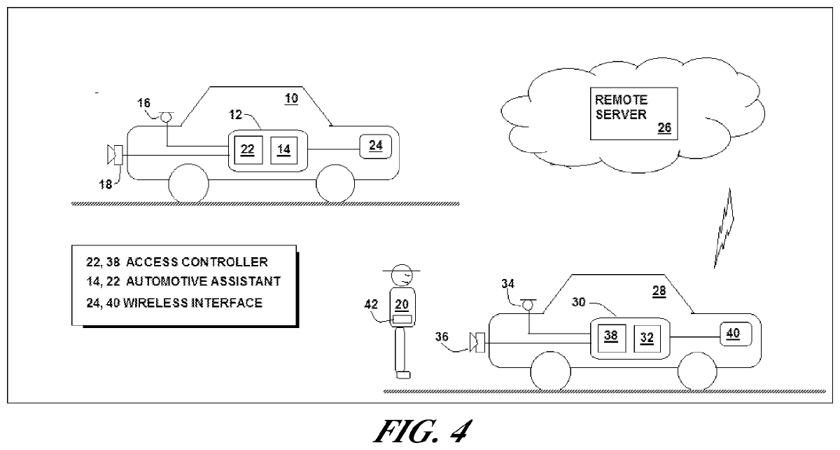

FIG. 3 shows both the vehicle 10 from FIG. 1 and an additional vehicle 28, which is among those in the fleet 27 shown in FIG. 2. For ease of exposition, the vehicle 10 shown in FIG. 1 will be referred to as the “first vehicle” and the additional vehicle 28 in FIG. 3 will hereafter be referred to as the “second vehicle 28.”

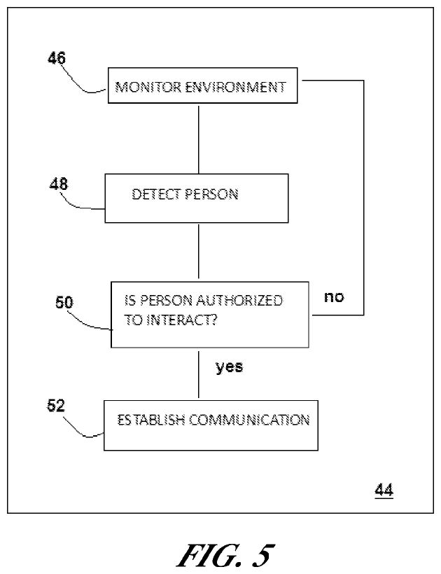

FIG. 4 shows the person 10 from FIG. 3 after having walked over to within speaking range of the second vehicle 28. Since the first and second vehicles 10, 28 belong to the same vehicle fleet 27, the person 20, who is shown interacting with the first vehicle's automotive assistant 14 in FIG. 2, is also able to interact with the second vehicle's automotive assistant 32. The combination of the first and second vehicles' respective automotive assistants 14, 32, along with automotive assistants of other vehicles in the relevant vehicle fleet 27, thus form what is essentially a distributed automotive assistant that functions as a “fleet assistant.”

Before the second vehicle's automotive assistant 32 interacts with the person 20, it must somehow know of the person's presence and the person's authorization to interact with the other automotive assistants of the fleet 27.

In some practices, knowledge concerning a person's authorization to interact with the fleet's automotive assistants arises as a result of the second vehicle's access controller 38 having received certain biometric information. In one example, a person 20, having recognized the second vehicle 28 as belonging to the same fleet 27 as the first vehicle 10, directly addresses the second vehicle 28 with a spoken utterance. This enables the second vehicle's access controller 38 to consult the remote server 26 to authenticate the utterance with a voice print. In some embodiments, the spoken utterance includes a wake-word.

Alternatively, an external camera provides an image of the person 20 to the second vehicle's access controller 38 to assist in establishing that person's authorization to interact with the fleet's automotive assistants 14, 32.

Alternatively, the second vehicle's access controller 38 detects the person's presence and the person's authorization to interact with the fleet's automotive assistants 14, 32 as a result of an interaction with portable circuitry 42 carried by the person 20.

Examples of such portable circuitry 42 include a key fob and a smartphone.

Once the portable circuitry 42 is close enough to the second vehicle 28, the second vehicle's access controller 38 detects its presence. The second vehicle's infotainment system 30 then prepares for interaction by acquiring information concerning the person 20, for example by interrogating the remote server 26.

In some cases, the second vehicle's access controller 38 detects a person 20 without the person 20 knowing that such detection has occurred. As a result, it is useful for the second vehicle's access controller 38 to announce that it has detected the person's presence. Otherwise, the person 20 would have no way of knowing that the second vehicle's infotainment system 30 is at that person's disposal.

The second vehicle's access controller 38 signals the person 20 in any one of a variety of ways. In some practices, the second vehicle's access controller 38 causes illumination of a light adjacent to the second vehicle's loudspeaker 36 or second vehicle's microphone 34. If necessary, the second vehicle's access controller 38 causes a more intrusive announcement using the second vehicle's loudspeaker 36.

A person 20 who observes a second vehicle 28 that is part of the fleet 27 is thus able to approach the second vehicle 28 and ask the sorts of questions that might have been asked of the first vehicle's automotive assistant 14. Examples of such questions include simply queries, such as, “What time is it?” or “Am I close to an ice-cream shop?” In addition to general inquiries along the lines of the foregoing, after the second vehicle's access controller 38 has granted the person 20 with access, the second vehicle's automotive assistant 32 is also able to access the person's data profile in much the same way as the first vehicle's automotive assistant 14. In some embodiments, the second vehicle's automotive assistant 32 does so by communicating with the remote server 26. Other embodiments implement peer-to-peer communication between the first infotainment system 12 and the second vehicle's infotainment system 30, potentially using the remote server 26 as a go-between. In either case, the second vehicle's automotive assistant's ability to access person data enables it to answer questions that rely on the person data, such as “Can you remind me of the address for my ten o'clock appointment?” In some embodiments, the second vehicle's access controller 38 recognizes the direction to the person 20 and directs the second vehicle's microphone 30 and the second vehicle's loudspeaker 36 accordingly. In such cases, the second vehicle's microphone 30 and the second vehicle's loudspeaker 36 are steerable, either mechanically or by providing appropriate phase delays to corresponding microphone elements or loudspeaker elements.

The examples given thus far might also have been carried out using a digital assistant of a smartphone. However, in some cases, the information sought is particular to vehicles.

For example, after having been granted by the second vehicle's access controller 38, a person 20 who has forgotten where the first vehicle 10 has been parked may ask the second vehicle's automotive assistant 32, “Do you know where my car is parked?” In such cases, the second vehicle's automotive assistant 32 establishes communication with the first vehicle's automotive assistant 14 and asks for its location. The first vehicle's automotive assistant 14, having access to a GPS, replies with its coordinates, which the second vehicle's automotive assistant 32 translates into a more user-friendly form before announcing the first vehicle's location to the grateful person 20. In some cases, the second vehicle's automotive assistant 32 goes so far as to text directions to the portable circuitry 42.

For those cases in which the first vehicle 10 is autonomous, a person 20 burdened with packages may stumble across a second vehicle 28 and, after having been granted access by the second vehicle's access controller 38, ask the second vehicle's automotive assistant 32 to instruct the first vehicle's automotive assistant 14 to cause the first vehicle 10 to drive to the second vehicle's location for a pick-up.

Still other cases make use of sensors present in the first vehicle 10. For example, a person 20 who suspects that a missing package is in the first vehicle's front seat would, after having been granted access by the second vehicle's access controller 38, ask the second vehicle's automotive assistant 32 to ask the first vehicle's automotive assistant 14 to use an internal camera in the first vehicle 10 to photograph the front seat and text the photograph to the portable circuitry 42 for inspection. The second vehicle's automotive assistant 32, having identified the person 20, retrieves all necessary information to carry out this request by communicating with the remote server 26.

While the foregoing examples pertain to matters of convenience, there are applications with life saving potential. For example, a person 20 who feels a sudden chest pain while near a second vehicle 28 could ask the second vehicle's automotive assistant 32 to make an emergency call for an ambulance. In some embodiments, the second vehicle's access controller 38 recognizes keywords and actions associated with an emergency, waives the requirement for authorization, and summons emergency assistance.

The interactions that have been discussed thus far are initiated by the person 20. However, in some practices, the second vehicle's automotive assistant 32 initiates the interaction upon detecting the person's presence. In one example, all automotive assistants 14, 32 receive a public safety announcement. In such a case, upon the second vehicle's access controller 38 having detected the person's presence, the second vehicle's automotive assistant 32 uses the second vehicle's loudspeaker 36 to relay details of the public safety announcement to the person. This provides a way to quickly spread news concerning such difficulties as traffic congestion, an accident, roadwork, an approaching emergency vehicle, a driver on the wrong side of the road, a police chase, animals on the road, a natural catastrophe, or crime scene, among other things.

In some practices, the public service announcement originates from some government agency. However, in other practices, the individual vehicles of the fleet 27 cooperate to monitor their respective environments and transmit updates to each other, thus creating a synergistic effect in which the fleet 27, as a whole, monitors a rapidly unfolding event much more completely than an any individual vehicle could hope to do. The fleet 27 thus establishes a network of individual automotive assistants that cooperate to track an event as it unfolds over a larger area, including such details as emergency-vehicle positions and velocities. In such cases, each vehicle uses sensors on its exterior, such as cameras and microphones, to monitor its local environment. This environmental information, combined with a vehicle's known location, is provided to the remote server 26 for use in monitoring an unfolding event.

Referring now to FIG. 5, a process 44 carried out by the second vehicle's infotainment system 30 begins with the second vehicle's access controller 38 detecting that a person is outside the second vehicle 28 (step 46). This is carried out by receiving biometric information from that person or by receiving information from portable circuitry 42 being carried by that person.

The process continues with determining whether that person is authorized to interact with any of the automotive assistants in the fleet 27 (step 48). If the person 20 is not so authorized, execution halts (step 50). Otherwise, communication is established between the person 20 and the relevant automotive assistant 32 (step 52).

It is to be understood that the foregoing description is intended to illustrate and not to limit the scope of the invention, which is defined by the scope of the appended claims. Other embodiments are within the scope of the following claims.

What is claimed is:

1. A method comprising
detecting that a person is outside a vehicle that is a member of a fleet of vehicles, each of said vehicles comprising an infotainment system and an external speech interface, said infotainment system comprising an automotive assistant and an access controller, said external interface comprising at least one of a microphone and a loudspeaker outside of said vehicle,
using said access controller, determining that said person is authorized to interact with all of said automotive assistants in said fleet, and
after having determined that said person is authorized, establishing communication between said person and a first automotive assistant, said first automotive assistant being one of said automotive assistants, and
after having established communication, using said external speech interface of said vehicle for, at least one of
receiving an utterance by said person and
transmitting an utterance by said automotive assistant.

2. The method of claim 1, further comprising retrieving, from a device carried by said person, information to be used for determining that said person is authorized to interact with any of said automotive assistants.

3. The method of claim 1, further comprising obtaining biometric data from said person and using said biometric data for determining that said person is authorized to interact with any of said automotive assistants.

4. The method of claim 1, further comprising receiving an utterance by said person and using said utterance for determining that said person is authorized to interact with any of said automotive assistants.

5. The method of claim 1, wherein there exists a manufacturer, wherein determining that said person is authorized to interact with any of said automotive assistants comprises determining that said person is authorized to interact with any automotive assistant in said fleet of vehicles, and wherein each vehicle in said fleet of vehicles has been encoded with information indicating that is manufactured by said manufacturer.

6. The method of claim 1, wherein there exists an ownership entity, wherein determining that said person is authorized to interact with any of said automotive assistants comprises determining that said person is authorized to interact with any automotive assistant in said fleet of vehicles, and wherein each vehicle in said fleet of vehicles has been encoded with information indicating that is owned by a said ownership entity.

7. The method of claim 1, wherein said vehicle is a first vehicle from said fleet of vehicles and wherein said first automotive assistant is an automotive assistant of a second vehicle from said fleet of vehicles.

8. The method of claim 1, wherein said first automotive assistant is an automotive assistant of said vehicle.

9. The method of claim 1, further comprising, after having established said communication, obtaining information from a second vehicle from said fleet of vehicles.

10. The method of claim 1, wherein said vehicle is a first vehicle from said fleet of vehicles and wherein said method further comprises, as a result of having established said communication using said external speech interface of said first vehicle, causing a second vehicle from said fleet of vehicles to execute an action.

11. The method of claim 1, wherein said vehicle is a first vehicle from said fleet of vehicles, wherein said fleet of vehicles comprises a second vehicle, wherein said first and second vehicles comprise respective first and second automotive assistants, wherein said person is an authorized driver of said second vehicle but not of said first vehicle, and wherein said person interacts with said second automotive assistant as if it were said first automotive assistant.

12. The method of claim 1, wherein said vehicle is a first vehicle from said fleet of vehicles, wherein said fleet of vehicles comprises a second vehicle, wherein said first and second vehicles comprise respective first and second automotive assistants, wherein said person is an authorized driver of said second vehicle but not of said first vehicle, and wherein establishing communication comprises establishing communication with said second automotive assistant.

13. The method of claim 1, wherein said vehicle is a first vehicle from said fleet of vehicles, wherein said fleet of vehicles comprises a second vehicle, wherein said first and second vehicles comprise respective first and second automotive assistants, wherein said person is an authorized driver of said second vehicle but not of said first vehicle, and wherein, in response to having determined that said person is authorized to interact with any of said automotive assistants, said first and second automotive assistants cooperate to form a distributed automotive assistant for use by said person.

14. The method of claim 1, further comprising, after having established said communication, wirelessly retrieving information from a remote server and using said information thus retrieved in the course of communicating with said person.

15. The method of claim 1, wherein using said speech interfaces comprises both receiving said utterance by said person and transmitting an utterance by said automotive assistant.

16. The method of claim 1, wherein using said speech interface comprises receiving said utterance by said person and wherein said method further comprises, in response to said utterance, causing another vehicle, which is also a member of said fleet, to move itself to another location.

17. The method of claim 1, wherein using said speech interface comprises receiving said utterance by said person and wherein said method further comprises, in response to said utterance, causing another vehicle, which is also a member of said fleet, to carry out mechanical work.

18. An apparatus comprising
an access controller and an automotive assistant,
wherein said automotive assistant is one of a plurality of automotive assistants, each of which is a constituent of an infotainment system,
wherein said access controller is one of a plurality of access controllers, each of which is a constituent of one of said infotainment systems,
wherein each of said infotainment systems is installed in a corresponding vehicle in a fleet of vehicles,
wherein said access controller is configured to determine whether a person who is outside of said vehicle is a person who is authorized to interact with said automotive assistant and also with all other automotive assistants in said fleet,
wherein said access controller is further configured to establish communication between said person and one of said automotive assistants in said fleet after having made said determination by using an external speech interface of said vehicle in which said automotive assistant is installed,
wherein said external speech interface is one of a plurality of external speech interfaces, each of which is installed in a corresponding one of said vehicles in said fleet of vehicles, and
wherein said automotive assistant is configured to communicate with any other automotive assistant in said fleet.

19. The apparatus of claim 18, further comprising a remote server, wherein each of said access controller is configured to establish communication between with said remote server.

20. The apparatus of claim 18, wherein said automotive assistant is configured to solicit information concerning said person from another automotive assistant from said plurality of automotive assistants. The apparatus of claim 18, wherein said access controller is configured to retrieve, from portable circuitry carried by said person, information for use in determining whether said person is authorized to interact with all of said automotive assistants.

22. The apparatus of claim 18, wherein said access controller is further configured to establish communication with another automotive assistant in said plurality of automotive assistants.

23. A manufacture comprising a tangible and non-transitory computer readable medium having encoded thereon instructions that, when executed by an infotainment system of a vehicle that is a member of a fleet of vehicles, cause execution of an access controller and an automotive assistant on said infotainment system, said access controller being configured to detect that a person outside said vehicle is authorized to interact with automotive assistants in all of said vehicles in said fleet using an external speech interface of said vehicle to either receive an utterance by said person or to transmit an utterance to said person.
